(19) United States
(12) Patent Application Publication
(10) Pub. No.: US 2022/0306510 A1
(43) Pub. Date: Sep. 29, 2022

(54) POLYMERIC STRUCTURE AND ITS USES

(71) Applicant: KEMIRA OYJ, Helsinki (FI)

(72) Inventors: Joonas LIKANDER, Espoo (FI); Rosa CARCELLER, Espoo (FI); Suhua WU, Shanghai (CN); Asko KARPPI, Turku (FI); Markus KORHONEN, Espoo (FI); Matti HIETANIEMI, Espoo (FI)

(21) Appl. No.: 17/619,444

(22) PCT Filed: Jun. 24, 2019
(86) PCT No.: PCT/CN2019/092555

§ 371 Date: Dec. 15, 2021

(51) Int. Cl. C02F 11/147; C08F 220/56; C08F 16/06

(52) U.S. Cl. CPC C02F 11/147; C08F 220/56; C08F 16/06

(57) ABSTRACT

A polymeric structure, which is obtained by polymerisation of (meth) acrylamide and at least one charged monomer in a polymerisation medium comprising at least a first host polymer, which first host polymer comprises polyvinyl alcohol. The polymeric structure may be used in making of paper, board, tissue or the like as a strength agent, or in dewatering of sludge.

### FIELD OF THE INVENTION

The present invention relates to a polymeric structure and its use according to the enclosed independent claims.

### BACKGROUND OF THE INVENTION

Controlling of strength characteristics are essential part in paper and board manufacturing. Strength properties are negatively affected when the amount of recycled fibres in the fibre stock increases, because the quality of fibres is reduced during the recycling. For example, each time the fibres are repulped the average fibre length tends to decrease. Various chemicals are added to the fibre suspension before the web forming in order to resist the effect of deteriorating fibre properties and for increasing, maintaining and improving the dry strength properties of the final paper or board product.

Use of recycled fibre raw material has been steadily increasing in manufacture of paper, board or the like, and a large portion of the fibre raw material is recycled more than once. Therefore, there is a need for novel effective compositions that can provide improved dry strength properties. Problems in floc structure may also reduce water drainage in press dewatering, which increases the drying demand in the succeeding drying steps, which thus may become the limiting part for the paper machine productivity.

The extensive recycling affects also quality of water, which is used in the manufacturing process of paper, board and the like. Nowadays the water circulations are practically closed or nearly closed in majority of paper and board mills and the use of fresh water is minimised. Together with the use of recycled raw material the closure of water circulations leads to increase in the concentration of charged species, such as ions, organic compounds, and other components in the water circulation, which also may affect the functionality of the strength additives. Hence, there is a need for efficient and cost-effective strength additives that are suitable for use even in processes where the concentration of ionic species in the process water may be high.

In addition to paper and board making processes, chemicals such as polymers are also used in sludge dewatering, for example, in municipal water treatment or industrial wastewater treatment, such as wastewaters from pulp and paper manufacturing. Wastewaters are treated in wastewater treatment processes, in which processes large quantities of wet sludge are typically formed. Various sludges comprising solid materials and/or microorganisms suspended in an aqueous phase. The sludge must be dewatered before it can be disposed. Dewatering can be done by using gravity, filtering, pressing or centrifugal force. The sludge is exposed to various forces, e.g. high shear forces, during the dewatering and other post-treatment steps. Sludges may be conditioned before thickening and dewatering by addition of chemicals, such as inorganic compounds of iron and lime, or organic compounds, such as polymer coagulants and flocculants. The chemicals are added to improve the sludge handling, to coagulate and/or flocculate the suspended solids into larger agglomerates and to increase dewatering effect. When the sludge is treated by using chemical addition, the formed flocs should resist various forces, e.g. shear forces, without breaking of the floc. This would ensure that high quality water phase with low turbidity is obtained from the dewatering step and that the solids content of the sludge is high after dewatering.

There is also a constant need for novel effective flocculants that can be used for dewatering of sludge from wastewater treatment processes, e.g. purification of municipal wastewater or wastewater from pulp, paper and/or board making processes.

### SUMMARY OF THE INVENTION

It is an object of the present invention to reduce or even eliminate the above-mentioned problems appearing in prior art.

One object of the present invention is to provide a water-soluble polymeric structure, which is effective in increasing the dry strength properties of paper, board or the like, especially the z-directional tensile strength (ZDT), SCT strength and burst strength. An object of the present invention is also to provide a polymeric structure which is effective in sludge dewatering.

These objects are attained with the invention having the characteristics presented below in the characterising parts of the independent claims. Some preferable embodiments are disclosed in the dependent claims.

The features recited in the dependent claims and the embodiments in the description are mutually freely combinable unless otherwise explicitly stated.

The exemplary embodiments presented in this text and their advantages relate by applicable parts to all aspects of the invention, even though this is not always separately mentioned.

Typical water-soluble polymeric structure according to the invention is obtained by polymerization of (meth)acrylamide and at least one charged monomer in a polymerization medium comprising at least a first host polymer, which first host polymer comprises polyvinyl alcohol having a degree of hydrolysis at least 70%, and the pH during the polymerization is acidic, preferably pH is in the range of 2-6.

Typical use of the polymeric structure according to the present invention is in making of paper, board, tissue or the like as a strength agent.

Another typical use of polymer structure according to the invention is in dewatering of sludge.

Typical method according to the present invention for treating a fibre stock or an aqueous sludge comprises an addition of the polymeric structure according to the invention to a fibre stock or an aqueous sludge comprising an aqueous phase and suspended solids, and dewatering said fibre stock or aqueous sludge.

Now it has been surprisingly found out that a polymeric structure, which is formed by polymerising (meth)acrylamide and at least one charged monomer in a polymerization medium comprising at least polyvinyl alcohol as a host polymer, provides unexpected improvement in the dry strength properties in paper and board manufacturing. The use of polyvinyl alcohol creates hydrogen bonds between hydroxyl functionality of polyvinyl alcohol and fibres and thus reinforcing the link between the polymers and fibres and giving better dry strength performance. It has also observed that the use of polyvinyl alcohol in the polymeric structure increases Z-directional strength by hydrogen bonding without decreasing bulk. The polymeric structure according to the present invention produces at the same time an improvement in one or more strength properties, such as tensile strength, burst strength, Z-directional strength and/or compression strength as well as a beneficial effect on the obtained bulk values. For example, compression strength and burst strength are important dry strength properties for paper and board, especially for board grades, which are used for packaging. Compression strength is often measured and given as Short-span Compression Test (SCT) strength, which may be used to predict the compression resistance of the final product. Burst strength indicates paper's or board's resistance to rupturing, and it is defined as the hydrostatic pressure needed to burst a sample when the pressure is applied uniformly across the side of the sample.

It has also been observed that the polymeric structure according to the present invention can be used even at conditions having elevated conductivities, alkalinity and/or hardness without significantly losing its performance. It is assumed, without wishing to be bound by a theory, that the presence of polyvinyl alcohol in the polymeric structure inhibits the effects of charged ions present in conditions at elevated conductivity, alkalinity and/or hardness to the polymeric structure, but the polymeric structure maintains its structure without substantial compressing.

Polymeric structure according to the present invention has also been observed to be an efficient polymer flocculant which provides improved dewatering of an aqueous sludge from wastewater treatment processes, e.g. purification of municipal wastewater or industrial wastewater, such as wastewater originating from pulp, paper and/or board making processes. Thus, the present invention provides an improved method for dewatering of sludge which may be observed an increase in sludge dryness. The polymeric structure according to an embodiment of the present invention, which is obtained by polymerizing of (meth)acrylamide and at least one cationic monomer in a polymerization medium comprising at least polyvinyl alcohol as a host polymer, comprises hydroxyl and acetyl groups in addition to the high molar mass and cationic charge from cationic polymer. The obtained polymeric structure comprises also hydrophobic groups within the one product, without sacrificing the solubility or molecular weight of the polymer. Polymeric structure formed according to the present invention has more complex structure than normal cationic polyacrylamide, without complicated synthesis process. This more complex polymeric structure is beneficial in dewatering of sludge, especially when the sludge comprises also different chemistries, including hydrophobic parts, for example fats and excrement lipids. It is speculated that the polymeric structure according to the present invention is able to interact with the solid constituents of the sludge in a manner that generates more robust flocs and enhances the dewatering performance. Furthermore, the flocculant comprising the polymeric structure tolerates well variations in process conditions.

### DETAILED DESCRIPTION OF THE INVENTION

The polymeric structure of the present invention is obtained by polymerisation of (meth)acrylamide and at least one charged monomer in a polymerization medium comprising at least a first host polymer. According to the present invention, the first host polymer comprises polyvinyl alcohol (PVA; PVOH) and a copolymer of (meth)acrylamide and at least one charged monomer as an interlacing second polymer. In the present context the polymeric structure denotes a structure or a polymeric material or a polymer that comprises at least two polymer networks (a first host polymer and a second polymer) which are at least partially interlaced with each other on a molecular scale but not covalently bonded to each other. Preferably there is no chemical bond between the host polymer(s) and the second polymer, but their chains are inseparably intertwined. The individual polymer networks cannot be separated from each other unless chemical bonds are broken. This means that the individual polymers forming the polymeric structure of the present invention cannot be separated from each other without breaking the individual polymer chains and thus the polymeric structure. In the present context the term “interlacing polymer” is used to denote the second polymer, which is formed by polymerisation of (meth)acrylamide and at least one charged monomer in a polymerization medium comprising at least a first host polymer, which first host polymer comprises polyvinyl alcohol having a degree of hydrolysis at least 70%. Polymeric structure according to the invention is a polymer composition which comprises polyvinyl alcohol having a degree of hydrolysis at least 70%, and a copolymer of (meth)acrylamide and at least one charged monomer, wherein the polymer chains of polyvinyl alcohol and said copolymer are inseparably intertwined in the polymeric structure.

Preferably the polymeric structure according to the present invention is obtained by free radical polymerisation.

The polymeric structure according to the present invention may be obtained by solution polymerisation or gel polymerisation of (meth)acrylamide and at least one charged monomer in the polymerisation medium comprising a first host polymer.

According to one embodiment of the invention the polymeric structure may be obtained by solution polymerisation of (meth)acrylamide and at least one charged monomer in the polymerisation medium. (Meth)acrylamide and the monomer(s) are added to the aqueous polymerisation medium, which comprising at least a first host polymer, and the formed reaction mixture is polymerised in presence of initiator(s) by using free radical polymerisation. The temperature during the polymerisation may be in the range of 60-100° C., preferably 70-90° C. During the polymerisation, the pH is usually acidic, both pH of the polymerisation medium and the obtained polymeric structure. According to an embodiment of the present invention pH is in the range of 2-6, preferably in the range of 2.5-5 and more preferably 2.8-4.5. In one preferred embodiment according to the invention, pH is about 3 during the polymerisation. At the end of polymerisation, the polymeric structure is in a form of a solution, which has a dry solids content of 10-25 weight-%, typically 15-20 weight-%.

According to another embodiment of the invention the polymeric structure may be obtained by gel polymerisation of (meth)acrylamide and at least one charged monomer in the polymerisation medium which comprising at least a first host polymer. (Meth)acrylamide and the monomer(s) are polymerised in presence of initiator(s) by using free radical polymerisation. The monomer content in the polymerisation medium at the beginning of the polymerisation may be at least 20 weight-%. The temperature in the beginning of the polymerisation may be less than 40° C. or less than 30° C. Sometimes the temperature in the beginning of the polymerisation may be even less than 5° C. or less than 0° C. The temperature during polymerisation may increase, for example to 100° C., or for example to 140° C., but typically the temperature remains below 100° C. during the polymerisation. The pH of the polymerisation medium and polymeric structure is usually acidic. According to an embodiment of the invention the pH is in the range of 2-6, preferably in the range of 2.5-5 and more preferably 2.8-4.5 during polymerisation. In one preferred embodiment according to the invention, pH is about 3 during the polymerisation. It has been observed that the low pH during polymerisation improves the solubility of the polymeric structure.

In the gel polymerisation the free radical polymerisation of the monomers in the polymerisation medium comprising at least first host polymer produces a polymeric structure, which is in form of gel or highly viscous liquid. The total polymer content in the obtained polymeric structure is at least 60 weight-%, for example at least 70 weight-%. After the gel polymerisation, the obtained polymeric structure is mechanically comminuted, such as shredded or chopped, as well as dried, whereby a particulate polymeric structure is obtained. Depending on the used reaction apparatus, shredding or chopping may be performed in the same reaction apparatus where the polymerisation takes place. For example, polymerisation may be performed in a first zone of a screw mixer, and the shredding of the obtained polymer composition is performed in a second zone of the said screw mixer. It is also possible that the shredding, chopping or other particle size adjustment is performed in a treatment apparatus, which is separate from the reaction apparatus. For example, the obtained water-soluble polymeric structure in gel form may be transferred from the second end of a reaction apparatus, which is a belt conveyor, through a rotating hole screen or the like, where it is shredded or chopped into small particles. After shredding or chopping the comminuted polymeric structure is dried, milled to a desired particle size and packed for storage and/or transport. According to one embodiment the polymeric structure may be dried to a solids content of at least 85 weight-%, preferably at least 90 weight-%, more preferably at least 95 weight-%. The obtained polymeric structure in a form of a dry particulate product is easy to store and transport and provides an excellent storage stability and long self-life. It is possible to obtain a polymeric composition having a higher polymer content by gel polymerization, which makes it also more cost efficient in view of the logistics. A high polymer content has the additional benefit of improved flocculation performance especially in sludge dewatering.

Polymerisation of the polymeric structure according to the present invention is carried out at acidic pH as disclosed above, irrespective of polymerisation method, which avoids or reduces the complex formation between the polymers during polymerization of the interlacing second polymer. The pH of the obtained polymeric structure is also acidic, typically in the range of 2-6. The pH value is typically determined by diluting or dissolving, if the polymeric structure is in dry particulate form, the polymeric structure to water at 0.1 weight-% solids concentration.

The polymerisation medium may further comprise pH adjustment agents, chelating agents and/or compounds, additives or residual substances associated with the host polymer(s) or its production, such as reaction products of used initiators. If desired, the polymerisation medium may comprise chain transfer agent(s).

Crosslinker may be present in one or more of host polymer(s) and/or in the second interlacing polymer. The amount of cross-linker may be less than 0.1 mol-%, preferably less than 0.05 mol-%, and for gel polymerised polymeric structures the preferred amount of optional cross-linker is less than 0.002 mol-%, preferably less than 0.0005 mol-%, more preferably less than 0.0001 mol-%. According to one preferred embodiment of the present invention, the polymeric structure is essentially free from crosslinker(s) and/or chain transfer agent(s).

The polymerisation medium comprises, already at the start of the polymerisation, at least a first host polymer. The polymerisation medium, irrespective of polymerisation method, thus comprises at least a first host polymer, which comprises polyvinyl alcohol having a degree of hydrolysis at least 70%. The polymerisation medium may further comprise one or more successive host polymers, which are structurally different from the first host polymer. The first host polymer and any of the successive host polymers may be added simultaneously or at any order to the polymerization. According to the present invention, the first host polymer comprises polyvinyl alcohol. The polymerisation medium comprises water soluble polyvinyl alcohol having a degree of hydrolysis at least 70% or preferably at least 75% or at least 80%. Water solubility of PVOH primarily depends upon degree of hydrolysis. Preferably, the polyvinyl alcohol has a degree of hydrolysis in the range of 75-100% or 75-99%, or more preferably 85-99%, or even more preferably 88-99%. In one preferred embodiment according to the present invention, polyvinyl alcohol is substantially complete hydrolysed, i.e. a degree of hydrolysis is about 98% or 99%. Solutions of substantially complete hydrolysed PVOH do not foam. The degree of the hydrolysis affect also tendency to create hydrogen bonds with suspended particles in a fibre stock and/or in an aqueous sludge. The part of polyvinyl alcohol that is not hydrolysed is considered to be hydrophobic, because instead of having -OH groups, it has acetyl groups. Thus, polyvinyl alcohol provides some hydrophobicity to the polymer composition which is beneficial e.g. in sludge dewatering. According to one preferred embodiment the polymeric structure, which is obtained by polymerising a second polymer in the presence of polyvinyl alcohol as a first host polymer, comprises hydrophobic acetyl groups. This more complex polymeric structure is beneficial in dewatering of sludge, especially when the sludge also comprises different chemistries, since complexity of the polymeric structure provides more efficient address of the different chemical groups and an improved interaction with chemistries presents in the sludge.

The polyvinyl alcohol used as a first host polymer may have an average molecular weight in a wide range. According to an embodiment of the present invention, the polyvinyl alcohol has an average molecular weight at least 5000 g/mol, preferably in the range of 5000-1 000 000 g/mol. Molecular weight of the polyvinyl alcohol depends on the polymerisation method of the polymeric structure and/or the application of the polymeric structure.

According to an embodiment of the invention the polymeric structure in a dry particulate form is obtained by gel polymerisation, wherein the polyvinyl alcohol may have an average molecular weight at least 5000 g/mol, preferably polyvinyl alcohol may have an average molecular weight in the range of 5000-1 000 000 g/mol. According to one embodiment of the invention, the polyvinyl alcohol may have a relatively high molecular weight, which may be observed to improve the performance of the polymeric structure and e.g. its flocculation ability in dewatering. According to another embodiment of the present invention, an average molecular weight of polyvinyl alcohol may be in the range of 20 000-250 000 g/mol, preferably in the range of 50 000-150 000 g/mol, when polymeric structure is obtained by solution polymerisation and the obtained polymeric structure is in a form of solution. These average molecular weight values, and especially the preferred ranges, are high enough so that the host polymer remains within the polymeric structure, and low enough to facilitate easy polymerisation of the interlacing polymer, and in the range improving water-solubility of the polymeric structure.

According to an embodiment of the present invention, the polymeric structure comprises at least 1 weight-% and typically 2-50 weight-% and more typically 3-30 weight-% or 5-25 weight-% of polyvinyl alcohol as the first host polymer, calculated from the total polymer content of the composition.

An amount of polyvinyl alcohol in the polymeric structure is dependent on the polymerisation method of the polymeric structure and/or an application of the polymeric structure. According to an embodiment of the invention, the polymeric structure obtained by the gel polymerisation comprises at least 1 weight-%, preferably 2-50 weight-%, more preferably 3-30 weight-%, and even more preferably 3-15 weight-%, of polyvinyl alcohol as the first host polymer, calculated from the total polymer content of the composition. According to another embodiment of the present invention, the polymeric structure obtained by solution polymerisation comprises at least 5 weight-%, preferably 10-30 weight-%, more preferably 10-25 weight-%, and even more preferably 15-25 weight-% or 20-25 weight-%, of polyvinyl alcohol as the first host polymer, calculated from the total polymer content of the composition.

The polymeric structure according to the present invention, comprises further a second polymer, which is a polymer obtained by polymerisation of (meth)acrylamide and at least one charged monomer(s). Charged monomer(s) may comprise cationic and/or anionic monomers. According to one preferred embodiment, charged monomer(s) comprises cationic monomers for providing efficient binding in papermaking process comprising anionically charged fibres and/or in sludge treatment comprising anionic trash. According to an embodiment of the invention, the second polymer of the polymeric structure is obtained by polymerisation of (meth)acrylamide and at least 1 mol-% of charged monomer(s), preferably 4-90 mol-% of charged monomer(s), calculated from total amount of non-ionic monomers, such as (meth)acrylamide, and the charged monomers. The amount of the charged monomer(s) is dependent on the polymerisation method of the polymeric structure and/or an application of the polymeric structure.

The second polymer of the polymeric structure according to an embodiment of the present invention may be obtained by gel polymerisation by copolymerisation of (meth)acrylamide and at least 10 mol-% of charged monomer(s), preferably 10-90 mol-%, more preferably 15-85 mol-%, and even more preferably 20-80 mol-%, of charged monomer(s), calculated from total amount of non-ionic monomers, such as (meth)acrylamide, and the charged monomers. In one preferred embodiment of the present invention, the second polymer of the polymeric structure may be obtained by gel polymerization by copolymerization of (meth)acrylamide and at least 10 mol-% of cationically charged monomer(s), preferably 10-90 mol-%, more preferably 15-85 mol-%, and even more preferably 20-80 mol-%, of cationically charged monomer(s), calculated from total amount of non-ionic monomers, such as (meth)acrylamide, and the charged monomers.

According to another embodiment of the present invention, the second polymer of the polymeric structure may be obtained by solution polymerization by copolymerization of (meth)acrylamide and at least 1mol-% of charged monomer(s), preferably at least 4 mol-% of charged monomer(s), and more preferably 4-90 mol-% of charged monomer(s), calculated from total amount of non-ionic monomers, such as (meth)acrylamide, and the charged monomers. According to an embodiment of the present invention, the second polymer of the polymeric structure may be obtained by solution polymerization by copolymerization of (meth)acrylamide and 4-40 mol-% and preferably 8-15 mol-% of charged monomer(s), calculated from total amount of non-ionic monomers such as (meth)acrylamide, and the charged monomers.

The second polymer of the polymeric structure according to the present invention may be obtained by polymerisation of (meth)acrylamide and the charged monomer, wherein the charged monomer may comprise cationically and/or anionically charged monomer(s). The cationically charged monomer(s) may comprise monomer(s) which is selected from group consisting of 2-(dimethylamino)ethyl acrylate (ADAM), [2-(acryloyloxy)ethyl]trimethylammonium chloride (ADAM-Cl), 2-(dimethylamino)ethyl acrylate benzylchloride, 2-(dimethylamino)ethyl acrylate dimethylsulphate, 2-dimethylaminoethyl methacrylate (MADAM), [2-(methacryloyloxy)ethyl]trimethylammonium chloride (MADAM-Cl), 2-dimethylaminoethyl methacrylate dimethylsulphate, [3-(acryloylamino)propyl] trimethylammonium chloride (APTAC), [3-(methacryloylamino)propyl] trimethylammonium chloride (MAPTAC), and diallyldimethylammonium chloride (DADMAC). Preferably the cationic monomer is [2-(acryloyloxy)ethyl] trimethylammonium chloride (ADAM-Cl) or diallyldimethyl-ammonium chloride (DADMAC). Preferably, cationic monomer for the second polymer [2-(acryloyloxy)ethyl]trimethylammonium chloride (ADAM-Cl) or diallyldimethylammonium chloride (DADMAC). The anionically charged monomers may comprise monomers(s), which is selected from unsaturated mono- or dicarboxylic acids, such as acrylic acid, methacrylic acid, maleic acid, itaconic acid, crotonic acid, isocrotonic acid; unsaturated sulfonic acids, such as 2-acrylamido-2-methylpropane sulfonic acid (AMPS), methallylsulfonic acid; vinyl phosphonic acids, and any of their mixtures, and their salts.

The second polymer of the polymeric structure according to an embodiment of the present invention may also be obtained by polymerisation of (meth)acrylamide with both cationically and anionically charged monomers, wherein the copolymer is amphoteric.

According to one preferred embodiment of the invention, the monomers of the interlacing second polymer are water soluble and solubility of the monomers is typically at least 1 g/L, more typically at least 5 g/L and even more typically at least 10 g/L.

According to one embodiment of the invention, the polymerisation medium may comprise, already at the start of the polymerisation, at least a first host polymer, and possibly one or more second host polymer(s), which are structurally different from the first host polymer. The second host polymer(s) may comprise anionic, cationic and/or amphoteric polymer(s). According to an embodiment of the present invention the second polymer may be a synthetic polymer, such as a copolymer of (meth)acrylamide and at least a charged monomer. When a polymerisation of the interlacing second polymer is carried out in a polymerization medium comprising polyvinyl alcohol as a first host polymer and at least one second host polymer, the polymeric structure according to present invention comprising at least three polymer networks which are at least partially interlaced with each other on a molecular scale but not covalently bonded to each other. The additional second host polymer(s) may provide additional properties to the polymer structure, such as different charges, hydrophobic or hydrophilic properties.

A polymeric structure according to the present invention may be in a form of a dry particulate product or a solution.

The polymeric structure of the present invention is essentially water-soluble. The term “water-soluble” is understood in the present context that the polymeric structure is fully miscible with water. When mixed with an excess of water, the polymeric structure is preferably essentially dissolved, and the obtained polymer solution is preferably essentially free from discrete polymer particles or granules. Preferably the polymeric structure contains at most 30 weight-%, preferably at most 20 weight-%, more preferably at most 15 weight-%, even more preferably at most 10 weight-%, of water-insoluble material. The water-solubility may improve the availability of the functional groups of the polymeric structure, thereby improving the interactions with other constituents present in the fibre stock or sludge.

According to one embodiment, the polymeric structure has
a standard viscosity at most 6 mPas, measured at 0.1 weight-% solids content in an aqueous NaCI solution (1 M), at 25° C., by using Brookfield DVII T viscometer with UL adapter, or
a bulk viscosity at most 10 000 mPas, measured at 10 weigh-% aqueous solution at pH 3 and 25° C. by using Brookfield DV1 viscometer, equipped with small sample adapter, spindle 31 with maximum rotation speed.

According to one embodiment, the polymeric structure, preferably obtained by gel polymerization, may have a standard viscosity SV of 2-6 mPas, preferably 3.5-4.8 mPas, measured at 0.1 weight-% solids content in an aqueous NaCl solution (1 M), at 25° C., using Brookfield DVII T viscometer with UL adapter, for providing efficient flocculation performance.

According to one embodiment the polymeric structure, preferably obtained by solution polymerisation, may have a bulk viscosity in the range of 100-15000 mPas, preferably 500-10 000 mPas, measured at 10 weigh-% aqueous solution at pH 3, 25° C. The bulk viscosity values are measured by using Brookfield DV1 viscometer, equipped with small sample adapter, spindle 31 with maximum rotation speed.

The polymeric structure according to the present invention may be used as dry strength agent in making of paper, board tissue or the like. It improves especially the Z-directional strength, burst strength and SCT strength values. In addition to good strength performance, the polymeric structure according to the invention provides good retention and drainage performance.

The polymeric structure may be added in a fibre stock in amount of 100-4000 g/kg dry stock. Before addition to the fibre stock the polymeric structure is dissolved and/or diluted to the suitable addition concentration, and it may be added either to the thick stock or thin stock, preferably to the thick stock.

In the present context, the term “fibre stock”, into which the polymeric structure according to the present invention is incorporated, is understood as an aqueous suspension which comprises not only fibres, but also fillers and other inorganic or organic material used for making of fibrous webs, such as paper, board or tissue. The fibre stock may also be called pulp slurry or pulp suspension. The fibre stock may comprise any fibres. In one embodiment of the invention, a fibre stock comprises at least 20 weight-%, preferably at least 30 weight-%, more preferably at least 40 weight-%, calculated as dry of recycled fibre material. In some embodiments the fibre stock may comprise even >70 weight-%, sometimes even >80 weight-%, of fibres originating from recycled fibre material. The polymeric structure of the present invention performs even when using high amounts of recycled fibre materials, even up to 100 weight-%.

Nowadays the water circulations are practically closed or nearly closed in majority of paper and board mills and the use of fresh water is minimised. Together with the use of recycled raw material the closure of water circulations leads to increase in the concentration of charged species, such as ions, organic compounds, and other components in the water circulation, which also may affect the functionality of the strength additives. The polymeric structure according to the present invention provides the dry strength performance even at elevated conductivity, alkalinity and/or hardness conditions. The polymeric structure according to the invention has good retention performance, strength and drainage performance at elevated conductivities, i.e. it does not start to lose its performance at elevated conductivities. Correspondingly, the performance maintains at alkalinity of the fibre stock.

Typical method according to an embodiment of the present invention for making paper or board comprises
obtaining a fibre stock,
adding a polymeric structure according to the present invention to the fibre stock,
forming the fibre stock into a fibre web.

The polymeric structure according to the invention is also suitable for an aqueous sludge dewatering in municipal or industrial processes. In the present disclosure, the term “sludge” may denote a sludge originating from wastewater treatment of a wastewater treatment plant. The sludge comprises an aqueous phase and suspended solid material. The composition of the sludge depends on the sludge genesis inside the wastewater treatment plant. Typically, a sludge treated in polymeric structure according to the present invention may be a mixture of primary and secondary sludge, and sometimes it may also comprise tertiary sludge, strongly depending on the locally installed methods of the wastewater treatment plant. Due to a difference in feed sludge and/or treatment conditions of the wastewater treatment plant, the sludge may contain different proportions of sludge from each treatment step of the wastewater treatment, which may be varying over days and weeks. The sludge may have a dry solids content in the range of 1-8 weight-%, preferably 3-5 weight-%. According to the present invention the sludge to be dewatered originates from a process treating municipal wastewater or industrial wastewaters.

In an embodiment of the invention, a sludge may be a sludge obtained at wastewater treatment plant without anaerobic digestion process. Anaerobic digestion is a residual solids treatment process. Solids removed from raw wastewater, known as primary sludge, and solids removed from the biological treatment processes, known as secondary sludge, are treated, after thickening in Dissolved Air Floatation Thickeners, in the anaerobic digestion process. A sludge to be treated may be undigested sludge, but it may also comprise at least partially digested sludge. In an embodiment of the invention, a sludge is a mixture of undigested and digested sludges.

Dewatering of sludge according to the present invention comprises an addition of a polymeric structure as a flocculant to the sludge for flocculating the sludge before the dewatering of the sludge. Preferably the polymeric structure is added to a sludge immediately before the dewatering. The polymeric structure may be added directly to a pipeline or the like where the sludge is transported to the dewatering. Dewatering of the sludge may be performed by using mechanical dewatering means, such as centrifuge(s), belt press or chamber press, preferably centrifuge(s).

A sludge may also be originated from manufacturing process of pulp, paper and/or board comprises an aqueous liquid phase and fibre material suspended in the aqueous phase. The fibre material is cellulosic fibre material originating from wood or non-wood sources, preferably from wood sources. It has been observed that the polymeric structure provides improved dewatering and higher solids content after pressing.

The polymeric structure may be added to a sludge in amount of 0.5-20 kg/t dry sludge, preferably 0.75-6 kg/t dry sludge, preferably 1-4 kg/t dry sludge and even more preferably 1.5-2.5 kg/t dry sludge.

Typical method according to the invention for dewatering of sludge, the method comprising
obtaining an aqueous sludge comprising an aqueous phase and suspended material,
adding a flocculant comprising the polymeric structure according to the present invention to said sludge to obtain a chemically conditioned sludge, and
dewatering said chemically conditioned sludge using mechanical dewatering means to obtain a dewatered sludge cake.

In one embodiment of the invention, a method for dewatering of sludge may further comprise adding of inorganic coagulant to said sludge. The inorganic coagulant is preferably added prior to the polymeric structure to said sludge. If the sludge is going to be pressed, inorganic coagulant is preferred to be added for the performance. According to an embodiment of the invention inorganic coagulant may be any suitable coagulant. Typically, ferric chloride is used as an inorganic coagulant.

### EXPERIMENTAL

A better understanding of the present invention may be obtained through the following examples which are set worth to illustrate but are not to be construed as the limit of the present invention.

### Determination Methods of Product Characteristics

### Bulk Viscosity (Viscosity of Solution Products)

Viscosity of polymer solution is determined by Brookfield DV1 viscometer, which is equipped with a small sample adapter. Viscosity is measured at 25° C. by a spindle 31 using maximum applicable rotation speed.

### Standard Viscosity (Viscosity of Dry Products)

Viscosity of the dry polymer products is determined in an aqueous NaCI solution (1 M), at 0.1 weight-% solids content at 25° C. by Brookfield DVII T viscometer with UL adapter.

### Dry Content

Dry content is determined by drying a known amount of polymer solution sample in an oven at 110° C. for three hours and then weighing the amount of dry material and then calculating the dry content by the equation: 100×(dry material, g/polymer solution, g).

pH

pH is determined at 25° C. by a pH meter Knick Portamess Type 911.

### Charge Density

Charge density (μekv/l) is determined by Mütek PCD 03.

### Determination of Molecular Size Characteristic of Anionic Polymers by Size Exclusion Chromatography (SEC)

Molecular size is determined with a GPC system equipped with integrated autosampler, degasser, column oven and refractive index detector. Eluent was an aqueous solution containing acetonitrile 2.5 wt-% and 0.1 M sodium nitrate, and a flow rate of 0.8 mL/min at 35° C. The column set consisted of three columns and a precolumn (Ultrahydrogel precolumn, Ultrahydrogel 2000, Ultrahydrogel 250 and Ultrahydrogel 120, all columns by Waters). A refractive index detector was used for detection. The molecular weights and polydispersity are determined using conventional (column) calibration with poly(ethyleneoxide)/poly(ethylene glycol) narrow molecular weight distribution standards (Polymer Standards Service). The injection volume was 50 μL with a sample concentration of between 0.1-4 mg/mL depending on the sample. Ethylene glycol (1mg/mL) was used as a flow marker.

### EXAMPLE 1

### Production of Polymeric Structure in Solution Form: Net Cationic Polymeric Structure with PVOH

An aqueous polymeric structure with polyvinyl alcohol (PVOH) was produced by a two-stage polymerization process. At first “successive second host polymer”, which is an anionic host polymer, is polymerized in the following procedure. De-ionized water 387 g was dosed into a reactor equipped with an agitator and a jacket for heating and cooling. The water is heated to 100° C. Monomer solution is made into a monomer tank by mixing acrylamide (37.5 wt-%) 525 g, sodium hypophosphite 0.5 g, acrylic acid 50 g and diethylenetriamine-penta-acetic acid, penta sodium salt (40%), 0.5 g. The monomer mixture is purged with nitrogen gas for 15 min. Initiator solution is made by dissolving ammonium persulfate 2 g in de-ionized water 34 g. Dosages of the monomer solution and the initiator solution are started at the same time. Dosing time of the monomer solution is 60 min and dosing time of the initiator solution is 105 min. Temperature is kept at 100° C. during dosing. When dosing of the initiator solution is completed, then the mixture is agitated for 30 min at 100° C. Reaction mixture is then cooled to 25° C. Characteristics of the “successive second host polymer” are presented in the Table 1.

TABLE 1
Characteristics of the successive second host polymer

| Characteristic | Determined values |
|---|---|
| Dry content, % | 25.9 |
| Viscosity, mPas | 1010 |
| pH | 4.2 |
| MWr, g/mol | 121 000 |
| MWn, g/mol | 14 600 |
| MWp, g/mol | 104 000 |

The second polymerization stage is to polymerize the second monomer set in an aqueous solution of the two host polymers: the first host polymer, which is PVOH product Mowiol 28-99 (98%) and the above described “successive second host polymer”, which is anionic. PVOH product Mowiol 28-99 (98%) 37 g is dissolved in a reactor, described in production of the host polymer, in 550 g de-ionized water by mixing at 90° C. temperature for 30 min. Successive second host polymer 106 g and citric acid 1 g are dosed into the reactor. pH is adjusted to 3.0 by adding sulfuric acid 50%, 2.1 g. The mixture is purged with nitrogen for 5 min and temperature is adjusted 80° C. by heating. The second monomer mixture is made in a monomer tank by mixing acrylamide (37.5 wt-%) 170 g, acryloyloxyethyltrimethylammonium chloride (80 wt-%) 24 g and diethylenetriamine-penta-acetic acid, penta sodium salt (40%), 0.38 g. pH of the second monomer mixture is adjusted to 3.0 by adding sulfuric acid 50%, 0.35 g. The monomer mixture is purged with nitrogen gas for 15 min. Initiator solution is made by dissolving ammonium persulfate 0.34 g in de-ionized water 34 g. Dosages of the monomer solution and the initiator solution are started at the same time. Dosing time of the monomer solution is 60 min and dosing time of the initiator solution is 90 min. Temperature is kept at 80° C. during dosing by heating and/or cooling. When dosing of the initiator solution is completed, then the mixture is agitated for 30 min at 80° C. Then an aqueous solution of ammonium persulfate 0.5 g and de-ionized water 20 g is dosed into the mixture at 20 min time. The mixture is reacted at 80° C. for 30 min. Reaction mixture is diluted with de-ionized water 56 g and the reaction mixture is then cooled to 25° C. Characteristics of the obtained product, “Polymeric structure”, which is a net cationic polymeric structure with PVOH, are presented in the Table 2.

TABLE 2
Characteristics of Polymeric structure

| | |
|---|---|
| Dry solids, % | 15.0 |
| Viscosity, mPas | 9010 |
| pH | 3.0 |
| Charge density at pH 7, meq/g | 0.2 |

### EXAMPLE 2

### Preparation of Water-Soluble Cationic Polymeric Structures “20PVOH” and “35PVOH” in Solution Form

A cationic polymeric structure in solution form, which comprises about 17 weight-% PVOH of total polymer content is prepared by polymerizing acrylamide and cationic monomer in polyvinyl alcohol, at pH of about 3.5, in the following procedure: a reactant solution was prepared from 743.1 g PVOH solution, which was achieved by dissolving 19.8 g of polyvinyl alcohol having degree of hydrolysis of 80% and molar mass of about 10 kDa (from Sigma-Aldrich CAS # 9002-89-5) into 723.3 g of de-ionized water at 90° C. for 30 min, and 154.1 g of acrylamide (50 wt-%), 0,942 g of sulfuric acid (93%), 3.1 g of sodium acetate dissolved in 34.7g of de-ionized water, 27.54 g of acryloyloxyethyltrimethylammonium chloride (ADAM-Cl, 80 wt-%), and 0.256 g of penta-Na salt of diethylenetriamine-penta-acetic acid (40%) are dissolved after cooling of PVOH solution. The mixture was purged with nitrogen gas and heated to about 80° C. A system of ammonium persulfate (total 0.625 g, dissolved in de-ionized water) and Na-metabisulfite (1 g, dissolved in de-ionized water) was used for initiating and controlling polymerization. The mixture was reacted at about 80° C. until completion, and then cooled to 25° C. This polymeric structure has bulk viscosity 16300 mPas and dry content 12.54%, The product is labeled as 20PVOH. Another cationic polymeric structure, labeled as 35PVOH, was prepared in same way but using 34.65 g of polyvinyl alcohol, thus containing about 26 w% of PVOH from total polymer content. 35PVOH had bulk viscosity at 13.7% solids content of 35500 mPas. A cationic reference polymer, labeled as PAM, was prepared in same way without using any polyvinyl alcohol, and had bulk viscosity at 11.8% solids content of 8230 mPas, corresponding approx. to Mw of 0.8 MDa. All these polymers contained cationic monomers of about 10 mol-% in the cationic second (last polymerized) polymer network.

### EXAMPLE 3

### Preparation of Gel Polymerized Polymeric Structures “3SPHOL50” and “DPSrdx” in Dry Form

A cationic polymeric structure “3SPHOL50” in powder form, which comprises about 6 weight-% PVOH of total polymer content is prepared by polymerizing acrylamide and cationic monomer in polyvinyl alcohol, at pH of about 4, in the following procedure: a reactant solution of monomers and polyvinyl alcohol was prepared from 9 g of polyvinyl alcohol having degree of hydrolysis of 80% and molar mass of about 10 kDa (from Sigma-Aldrich CAS # 9002-89-5) in deionized water, 250.6 g of 50% acrylamide solution, 32.9 g of 80% ADAM-Cl, 2.96 g of Na-gluconate, 0.01 g of 40% DTPA Na-salt, 1.88 g of adipic acid, 7.21 g of citric acid, and 4.44 g of dipropylene glycol. The mixture was stirred until solid substances were dissolved, and pH adjusted to around 4 with citric acid. The initiator was 5 ml of 6% 2-hydroxy-2-methylpropiophenone in polyethylene glycol-water (1:1 by weight) solution. After the reactant solution was prepared according to the above description, it was purged with nitrogen flow in order to remove oxygen. The initiator, 2-hydroxy-2-methylpropiophenone in polyethylene glycol-water (1:1 by weight), was added to the reactant solution, and the solution was placed on a tray to form a layer of about 1 cm under UV-light, mainly on the range 350-400 nm (AS1/AS2/AS3=10/5/25). Intensity of the light was increased as the polymerization proceeded to complete the polymerization (from about 550 μW/cm² to about 2000 μW/cm²). The obtained gel was run through an extruder and dried to a moisture content less than 10% at temperature of 60° C. The dried polymer was ground and sieved to particle size 0.5-1.0 mm. The product is labeled as “3SPHOL50”. It had standard viscosity of about 3.4 mPas, corresponding to molecular weight of about 3.5 MDa, and contained cationic monomers of about 7 mol-% in the cationic second (last polymerized) polymer network.

Another cationic polymeric structure “DPSrdx” with PVOH of higher molar mass in powder form is prepared by polymerizing acrylamide and cationic monomer in polyvinyl alcohol, at pH of about 3-4, in the following procedure: a reactant solution of monomers and polyvinylalcohol was prepared from 17.93 g of polyvinyl alcohol having degree of hydrolysis of about 99.4% and molar mass of about 100 000 g/mol (from Sigma-Aldrich) in deionized water, 405.74 g of 50% acrylamide solution, 77.37 g of 80% ADAM-Cl, 3.87 g of 0.1% Na-hypophosphite, 0.64 ml g of 5% DTPA Na-salt, and 1.66 g of adipic acid. The mixture was stirred until solid substances were dissolved, and pH adjusted to abound 3-4. The initiator system comprised 5 ml of aqueous V50 solution (0.77 g/7 ml) as thermal initiator, and a redox pair of 5 ml of 0.098% ammonium persulfate and 5 ml of 0.053% ferrous ammonium sulphate. After the reactant solution was prepared according to the above description, thermal initiator was added and the reactant solution was degassed at low temperature by nitrogen gas. The redox pair was then injected to the reactant solution to start the polymerization. The obtained gel was run through an extruder and dried to a moisture content less than 10% at temperature of 60° C. The dried polymer was ground and sieved to particle size 0.5-1.0 mm.

This polymeric structure containing about 6 weight-% of PVOH from total polymer content was labeled as “DPSrdx”. It had standard viscosity of about 3.4 mPas and contained cationic monomers of about 10 mol-% in the cationic second (last polymerized) polymer network.

### Application Experiments

Application experiments 1 and 3 were performed for providing information about the behaviour and effect of the polymeric structures according to the present invention as dry strength compositions. Tables 3 and 4 give methods and standards used for pulp characterisation and sheet testing in the application experiments.

TABLE 3
Pulp characterization methods

| Property | Device/Standard |
|---|---|
| pH | Knick Portamess 911 |
| Turbidity (NTU) | WTW Turb 555IR |
| Conductivity (mS/cm) | Knick Portamess 911 |
| Charge (μekv/l) | Mütek PCD 03 |
| Zeta potential (mV) | Mütek SZP-06 |
| Consistency (g/l) | ISO 4119 |

TABLE 4
Sheet testing devices and standard methods
used for produced paper sheets.

| Measurement | Device | Standard |
|---|---|---|
| Basis weight | Mettler Toledo | ISO 536 |
| Ash content, 525° C. | — | ISO 1762 |
| Compressive strength SCT | Lorentzen & Wettre | ISO 9895 |
| Taber, bending stiffness | PTA | Tappi T 569 |
| Z-directional tensile (ZDT) | Lorentzen & Wettre | ISO 15754 |
| Tensile strength | Lorentzen & Wettre | ISO 1924-3 |

### Application Example 1

This Example simulates preparation of corrugating paper such as testliner or fluting. Central European testliner board was used as raw-material. This testliner contains about 17% ash and 5% surface size starch. Dilution water was made from tap water by adjusting conductivity to 4 mS/cm with salt mixture of calcium acetate 70%, sodium sulfate 20% and sodium bicarbonate 10%. Testliner board was cut to 2×2 cm squares. 2.7 l of dilution water was heated to 70° C. The pieces of testliner were wetted for 10 minutes in dilution water at 2% concentration before disintegration. Slurry was disintegrated in Britt jar disintegrator with 30 000 rotations. Pulp was diluted to 0.6% by adding dilution water.

In hand sheet preparation the used chemicals were added to the test fibre stock in a dynamic drainage jar (DDJ) under mixing, 1000 rpm. Strength chemicals were diluted before dosing to 0.1 weight-% concentration. The polymeric structure according to Example 1 is used as a strength chemical. Reference “Ref pol.” is similar polymer than the polymeric structure of Example 1, but without PVA. The addition amounts of the used strength chemicals are given in Table 5. The strength chemicals are added to the test fibre stock 30 s prior to sheet making. CPAM retention polymer was dosed at dosage of 0.2 kg/t 10 s prior to sheet making. The CPAM dosage was adjusted to get 15% ash content of the handsheet. All chemical amounts are given as kg dry active chemical per ton dry fibre stock.

Handsheets having basis weight of 110 g/m² were formed by using Rapid Köthen sheet former with 4 mS/cm conductivity in backwater, adjusted with salt mixture of calcium acetate 70%, sodium sulfate 20% and sodium bicarbonate 10%, in accordance with ISO 5269-2:2012. The handsheets were dried in vacuum dryers for 6 minutes at 92° C., at 1000 mbar. Before testing the handsheets were pre-conditioned for 24 h at 23° C. in 50% relative humidity, according to ISO 187.

TABLE 5
Hand sheet tests of application example 1:
chemical additions and measured results.

| | Ref pol. | Example 1 | SCT index |
|---|---|---|---|
| Test | kg/t dry | kg/t dry | Nm/g |
| 1 | 0 | | 19.6 |
| 2 | 3 | | 20.3 |
| 3 | | 3 | 21.0 |

The results, presented in Table 5, show that the polymeric structure according to the present invention increase SCT index.

### Application Example 2

Example 1 simulates preparation of corrugating paper such as testliner or fluting. Central European testliner board was used as raw-material. This testliner contains about 17% ash and 5% surface size starch. Dilution water was made from tap water by adjusting Ca²⁺ concentration to 520 mg/l by CaCl₂ and by adjusting conductivity to 4 mS/cm by NaCl. Testliner board was cut to 2×2 cm squares. 2.7 l of dilution water was heated to 70° C. The pieces of testliner were wetted for 10 minutes in dilution water at 2% concentration before disintegration. Slurry was disintegrated in Britt jar disintegrator with 30 000 rotations. Pulp was diluted to 0.6% by adding dilution water.

In hand sheet preparation the used chemicals were added to the test fibre stock in a dynamic drainage jar under mixing, 1000 rpm. Strength chemicals were diluted before dosing to 0.1 weight-% concentration. The used strength chemicals and their addition amounts are given in Table 6. The polymeric structures according to the present invention “20PVOH”, “35PVOH” and “3SPHOL50” are described in Examples 2 and 3. The reference chemical “PAM” was copolymer of ADAM-Cl and acrylamide (cationic charge 10 mol-%, MW=800 000 g/mol). The strength chemicals are added to the test fibre stock 30 s prior to sheet making. In addition to the strength chemicals the retention chemical, CPAM, was dosed at dosage of 0.2 kg/t 10 s prior to sheet making. All chemical amounts are given as kg dry active chemical per ton dry fibre stock.

Handsheets having basis weight of 80 g/m² were formed by using Rapid Köthen sheet former with 4 mS/cm conductivity in backwater, adjusted with CaCl₂ (520mg/l Ca²⁺) and NaCl, in accordance with ISO 5269-2:2012. The handsheets were dried in vacuum dryers for 6 minutes at 92° C., at 1000 mbar. Before testing the handsheets were pre-conditioned for 24 h at 23° C. in 50% relative humidity, according to ISO 187.

TABLE 6
Hand sheet tests of application example 2: chemical additions
and measured results.

| | | | | | SCT | Burst |
|---|---|---|---|---|---|---|
| | PAM | 20PVOH | 35PVOH | 3SPHOL50 | index | index |
| Test | kg/t dry | kg/t dry | kg/t dry | kg/t dry | Nm/g | kPam²/g |
| 1 | 0 | | | | 21.8 | 1.6 |
| 2 | 1 | | | | 22.3 | 1.8 |
| 3 | | 1 | | | 23.1 | 1.8 |
| 4 | | 3 | | | 23.6 | 1.8 |
| 5 | | | 1 | | 22.7 | 1.8 |
| 6 | | | 3 | | 23.6 | 1.9 |
| 7 | | | | 1 | 22.8 | 1.8 |

The results, presented in Table 6, show that the polymeric structures according to the present invention increase SCT index and burst index.

### Application Example 3

The effect of addition of the polymeric structure “DPSrdx” of cationic polyacrylamide (CPAM) and polyvinylalcohol (PVOH) in the multi-component strength system on the z-directional tensile strength (ZDT) was studied with folding box board furnish containing CTMP pulp (80%) and coated broke (20%). The polymeric structure “DPSrdx” was prepared with gel polymerization as presented in Example 3. 150 g/m² sheets were formed with dynamic sheet former (DSF) as follows: Test fibre stock was diluted to 0.6% consistency with deionized water, and pH was adjusted to 7 and conductivity to 1.5 mS/cm. The obtained pulp mixture was added to DSF. Chemical additions were made to mixing tank of DSF. Water was drained out after all the pulp was sprayed. Drum was operated with 1250 rpm, mixer for pulp 450 rpm, pulp pump 950 rpm/min, number of sweeps 100 and scoop time was 60 s. Sheet was removed from drum between wire and 1 blotting paper on the other side of the sheet. Wetted blotting paper and wire were removed. Sheets were wet pressed at Techpap nip press with 5 bar pressure with 2 passes having new blotting paper each side of the sheet before each pass. Dry content was determined from the pressed sheet by weighting part of the sheet and drying the part in oven for 4 hours at 110° C. Sheets were dried in restrained condition in drum dryer. Drum temperature was adjusted to 92° C. and passing time to 1 min. Four passes were made. First two passes with between blotting papers and 2 passes without. Before testing in the laboratory sheets were pre-conditioned for 24 h at 23° C. in 50% relative humidity, according to the standard ISO 187.

Strength additives used in the experiments were cationic starch (8kg/t) and a mixture of cationic waxy starch and the polymeric structure “DPSrdx” (addition levels of 1.5 and 2.5 kg/t) and anionic polymer strength additive (2,4 kg/t). All chemical amounts were kg dry chemical per ton dry fibre stock. The polymeric structure “DPSrdx” was a dry polymer and in said polymeric structure the CPAM had a substitution degree of 10 mol-% and proportion of PVOH was 6 wt-%. All points included retention aids (CPAM 200 g/t and APAM 200 g/t).

Results, presented in Table 7, show that the polymeric structure “DPSrdx” according to the present invention increases substantially Z-directional strength without decreasing bulk in a multicomponent strength system.

TABLE 7
Effect different strength systems on board properties

| | ZDT | Tensile index | Bulk |
|---|---|---|---|
| | [kPa] | [Nm/g] | [cm³/g] |
| No strength additives | 102 | 10.1 | 2.78 |
| Starch 8 kg/t + 2.4 kg/t | 177 | 15.0 | 2.64 |
| anionic strength additive | | | |
| Starch 8 kg/t + 1.5 kg/t | 219 | 14.6 | 2.68 |
| mixture of DPSrdx and waxy | | | |
| starch + 2.4 kg/t anionic | | | |
| strength additive | | | |
| Starch 8 kg/t + 2.5 kg/t | 233 | 15.2 | 2.70 |
| mixture of DPSrdx and waxy | | | |
| starch + 2.4 kg/t anionic | | | |
| strength additive | | | |

### Application Example 4

Application example 4 was performed for providing information about the behaviour and effect of the polymeric structures according to the present invention in sludge dewatering.

Polymeric structure of cationic polyacrylamide and polyvinyl alcohol (PVOH) comprises PVOH as a first host polymer and the second polymer, which is polymerized in a polymerization medium comprising the first host polymer, is a copolymer of acrylamide and 30 mol-% [2-(acryloyloxy)ethyl]trimethyl ammonium chloride (ADAM-Cl). The amounts of PVOH are 6 and 9 weight-% in polymerization medium. PVOH used is varied in molar masses and degree of hydrolysis. The properties of PVOH used in this study are shown in Table 8. The final dry polymer composition comprises both polymers, cationic polyacrylamide and PVOH.

TABLE 8
Polyvinyl alcohol properties.

| Polyvinyl alcohol | Molar | Degree of | Degree of |
|---|---|---|---|
| names | mass | hydrolysis | polymerization |
| PVOH-80 | 9 500 | 80 | n/a |
| PVOH 15-99 | 100 000 | 99.4 | n/a |
| PVOH 56-98 | 195 000 | 98 | 2400 |

All polyvinyl alcohol products are dry. For making the aqueous solution of PVOH, the polymers are dissolved in water at high temperature (about 95° C.) for the required time to make a clear and transparent aqueous solution (about 1 hour) under vigorous stirring. A round flask is used equipped with a mechanical stirrer and a refrigerant. The flask is immersed in an oil bath. The PVOH aqueous solution is cold down and used to make the cationic polyacrylamide reaction in it. Reaction characteristics and polymer properties of polymers made with PVOH are shown in Table 9. The polymerisations of the polymeric structures were prepared as essentially as the polymeric structure “DPSrdx” presented in Example 3.

The commercial dry cationic polyacrylamide is used as a reference, which is commonly formed by a polymerization reaction using acrylamide and 30 mol-% of [2-(acryloyloxy)ethyl]trimethyl ammonium chloride (ADAM-Cl).

TABLE 9

| | | Standard | | | |
|---|---|---|---|---|---|
| | | viscosity SV, | Insolubles, | Reaction | |
| | PVOH | mPas | wt-% | time | Max T |
| Polymers | wt-% | (QCTM 20) | (QCTM 37) | h:min | ° C. |
| Reference | 0 | 4.09 | <0.01 | 0:32 | 87.2 |
| cPAM-PVOH-6 | 6 | 3.64 | <0.01 | 0:34 | 87.9 |
| (PVA-80) | | | | | |
| cPAM-PVOH-9 | 9 | 3.7 | <0.01 | 0:52 | 97.32 |
| (PVA-80) | | | | | |
| cPAM-PVOH-6 | 6 | 3.56 | 0.2 | 0:18 | 89.8 |
| (15-99) | | | | | |
| cPAM-PVOH-6 | 6 | 4.11 | <0.01 | 0:28 | 94.21 |
| (56-98) | | | | | |

Sludge conditioning and mechanical dewatering by Minipress were studied as follows. A beaker is provided with 220 g sludge. The sludge is subjected to rapid mixing of about 300 rpm. A calculated amount of ferric chloride is added, and followed by mixing for 2 min. Then the conditioned sludge is flocculated by addition of 2 kg/t polymer. The sludge is once again subjected to rapid mixing for about 2-5 seconds. Once flocs are formed, the mixing is stopped. All the conditioned sludge in the beaker is transferred to a Minipress for dewatering. After the Minipress testing is completed, the obtained the sludge cake is retrieved and measurement of the cake dryness (i.e. solids contents) is made by using heating in an oven over night at 105° C.

The sludge is mainly undigested sludge from a wastewater treatment plant mainly treating municipal wastewater. The incoming sludge has pH of 6.2-7.0 and a solids content of about 3.17-5.0 weight-%.

Table 10 shows dryness after the sludge is conditioned by ferric chloride and polymeric structure comprising PVOH-80. Table 11 shows dryness after the sludge is conditioned by ferric chloride and polymeric structure comprising PVOH 15-99 or PVOH 56-98.

In the results can be observed an increase in sludge dryness with polymeric structure according to the invention compared to the reference samples.

TABLE 10

| | | Sludge dryness |
|---|---|---|
| | | after dewatering |
| Test | | (%) |
| 1 | Reference | 31.5% |
| | cPAM-PVOH-6(PVOH-80) | 33.6% ( [symbol] 2.1%) |
| 2 | Reference | 27.0% |
| | cPAM-PVOH-6(PVOH-80) | 28.2% ( [symbol] 1.2%) |
| 3 | Reference | 25.6% |
| | cPAM-PVOH-6(PVOH-80) | 26.0% ( [symbol] 0.4%) |
| 4 | Reference | 24.1% |
| | cPAM-PVOH-6(PVOH-80) | 24.3% ( [symbol] 0.2%) |
| | cPAM-PVOH-9-(PVOH-80) | 25.6% ( [symbol] 1.5%) |
| | cPAM-PVOH-12(PVOH-80) | 25.7% ( [symbol] 1.6%) |

TABLE 11

| | | Sludge dryness |
|---|---|---|
| | | after dewatering |
| Test | | (%) |
| 1 | Reference | 31.5% |
| | cPAM-PVOH-6(15-99) | 34.9% ( [symbol] 3.4%) |
| 2 | Reference | 27.0% |
| | cPAM-PVOH-6(15-99) | 28.2% ( [symbol] 2.1%) |
| 4 | Reference | 24.1% |
| | cPAM-PVOH-6(56-98) | 25.1% ( [symbol] 1.0%) |

1. A water-soluble polymeric structure, which is obtained by polymerization of (meth)acrylamide and at least one charged monomer in a polymerisation medium comprising at least a first host polymer, which first host polymer comprises polyvinyl alcohol (PVA) having a degree of hydrolysis at least 70%, and the pH during the polymerization is acidic, preferably pH is in the range of 2-6.

2. The water-soluble polymeric structure according to claim 1, wherein the polymeric structure is obtained by solution polymerisation or gel polymerisation.

3. The water-soluble polymeric structure according to claim 1, wherein polymeric structure has
a standard viscosity at most 6 mPas, measured at 0.1 weight-% solids content in an aqueous NaCl solution (1 M), at 25° C., by using Brookfield DVII T viscometer with UL adapter, or
a bulk viscosity at most 10 000 mPas, measured at 10 weight-% aqueous solution at pH 3 and 25° C. by using Brookfield DV1 viscometer, equipped with small sample adapter, spindle 31 with maximum rotation speed.

4. The water-soluble polymeric structure according to claim 2, wherein the polymeric structure is obtained by gel polymerisation in a form of a dry particulate product and has a standard viscosity SV of 2-6 mPas, preferably 3.5-4.8 mPas, measured at 0.1 weight-% solids content in an aqueous NaCl solution (1 M), at 25° C., by using Brookfield DVII T viscometer with UL adapter.

5. The water-soluble polymeric structure according to claim 2, wherein the polymeric structure is obtained by solution polymerisation and has a bulk viscosity in the range of 100-15 000 mPas, preferably 500-10 000 mPas, measured at 10 weigh-% aqueous solution at pH 3 and 25° C. by using Brookfield DV1 viscometer, equipped with small sample adapter, spindle 31 with maximum rotation speed.

6. The water-soluble polymeric structure according to claim 1, wherein the polymeric structure comprises at least 1 weight-% and typically 2-50 weight-% and more typically 3-30 weight-% or 5-25 weight-% of polyvinyl alcohol as the first host polymer, calculated from the total polymer content of the composition.

7. The water-soluble polymeric structure according to claim 1, wherein the polyvinyl alcohol has a degree of hydrolysis in the range of 75 — 99%, preferably 85-99%, more preferably 88-99%, and even more preferably the polyvinyl alcohol has a degree of hydrolysis 98% or 99%.

8. The water-soluble polymeric structure according to claim 1, wherein the polyvinyl alcohol has an average molecular weight at least 5000 g/mol, preferably in the range of 5000-1 000 000 g/mol.

9. The water-soluble polymeric structure according to claim 1, wherein the polymeric structure is obtained by polymerisation of (meth)acrylamide and at least 1 mol-% of charged monomer(s), preferably 4-80 mol-%, calculated from total amount of non-ionic monomers, such as (meth)acrylamide and the charged monomer(s).

10. The water-soluble polymeric structure according to claim 1, wherein the at least one charged monomer(s) comprises cationic and/or anionic monomers.

11. The water-soluble polymeric structure according to claim 1, wherein the polymeric structure is obtained by polymerisation of (meth)acrylamide and charged monomer(s), wherein the at least one charged monomer comprises
a cationically charged monomer, which is selected from group consisting of 2-(dimethylamino)ethyl acrylate (ADAM), [2-(acryloyloxy)ethyl]trimethylammonium chloride (ADAM-Cl), 2-(dimethylamino)ethyl acrylate benzylchloride, 2-(dimethylamino)ethyl acrylate dimethylsulphate, 2-dimethylaminoethyl methacrylate (MADAM), [2-(methacryloyloxy)ethyl]trimethylammonium chloride (MADAM-Cl), 2-dimethylaminoethyl methacrylate dimethylsulphate, [3-(acryloylamino)propyl]trimethylammonium chloride (APTAC), [3-(methacryloylamino)propyl]trimethylammonium chloride (MAPTAC), and diallyldimethyl-ammonium chloride (DADMAC), and/or
an anionically charged monomer, which is selected from unsaturated mono- or dicarboxylic acids, such as acrylic acid, methacrylic acid, maleic acid, itaconic acid, crotonic acid, isocrotonic acid; unsaturated sulfonic acids, such as 2-acrylamido-2-methylpropane sulfonic acid (AMPS), methallylsulfocnic acid; vinyl phosphoric acids, any of their mixtures, and their salts.

12. The water-soluble polymeric structure according to claim 1, wherein the polymerisation medium further comprises one or more second host polymer(s), which comprises anionic, cationic and/or amphoteric polymer(s).

13. A method to make paper, board, or tissue, wherein the water-soluble polymeric structure according to claim 1 is added as a strength agent.

14. The method according to claim 13, wherein the water-soluble polymeric structure is added in a fibre stock in amount of 100-4000 g/kg dry pulp.

15. A method to dewater a sludge comprising an aqueous phase and suspended solids, wherein the water-soluble polymeric structure according to claim 1 is added into the sludge.

16. The method according to claim 15, wherein the water-soluble polymeric structure is added into the sludge in amount of 0.5-20 kg/ton dry sludge, preferably 0.75-6 kg/ton dry sludge, preferably 1-4 kg/ton dry sludge and even more preferably 1.5-2.5 kg/ton dry sludge.

17. (canceled)
